(19) United States
(12) Patent Application Publication
(10) Pub. No.: US 2004/0167815 A1
(43) Pub. Date: Aug. 26, 2004

(54) Buyer loyalty program

(76) Inventor: Sharon Cozette DeLaHunt, Boise, ID (US)

Correspondence Address: Hewlett-Packard Development Company, L.P., Intellectual Property Administration, P.O. Box 272400, Fort Collins, CO, 80527-2400, US

(21) Appl. No.: 10/372,457

(22) Filed: Feb. 21, 2003

(51) Int. Cl. G06F 17/60

(52) U.S. Cl. 705/14

(57) ABSTRACT

Various systems, programs, and methods of a buyer loyalty program (BLP) are provided. A representative method for establishing buyer loyalty includes: accepting a member-buyer into a BLP and providing products to a reseller, wherein the reseller is registered in the BLP as a partner reseller of the products. The method further includes: receiving information from the reseller, wherein the information comprises purchase activity of the products by member-buyers; providing a coupon to a member-buyer when a member-buyer buys a pre-selected amount of the products from the reseller, wherein the coupon is redeemed at the reseller for a discount on products; and refunding the reseller a portion of the discount sustained by the reseller upon honoring the coupon.

### FIELD OF THE DISCLOSURE

The present disclosure is generally related to a program for facilitating buyer loyalty, and in particular to a program for facilitating buyer loyalty of a first party's products through a second party.

### BACKGROUND OF THE DISCLOSURE

Attracting new customers and building the new and old customers' loyalty are fundamental practices of any company and are typically built into a company's marketing plan. Incentive programs and loyalty programs have become quite popular and have been relatively successful in attracting new customers and retaining business. For the most part, incentive and loyalty programs may be interchanged to provide for essentially the same outcomes: increased sales, product awareness, and customer loyalty.

Generally, incentive programs offer awards and incentives to modify behavior of individual consumers and to direct the consumers to some pre-determined action, such as purchase of products or services upon visiting a retail site, viewing advertising, testing a product, or the like. Companies use awards and incentives to increase awareness of product offerings, to launch new products, to attract the attention of a newly identified audience, to differentiate products to encourage certain behavior, to obtain information, and for other purposes.

Loyalty programs are designed not only to attract new customers but also to build loyalty among existing customers. Generally, loyalty programs include some type of reward for those customers that have purchased a sufficient amount of product or service in a given time period. Perhaps the most notable loyalty programs are the frequent flyer programs offered by many airlines. An airline will reward a customer with “miles” for flights flown with that airline as well as for other qualifying purchases of a partner companies products. Eventually, once a customer has attained enough “miles,” the customer may redeem them for free flights, upgrades, etc. Partnering with incentive and loyalty programs has become quite popular in that it provides another avenue for a customer to attain points, e.g. “miles,” from a sponsoring company. The partner company also benefits because it may attract customers to their places of business, thus altering a customer's buying habits, in the partner company's favor. Generally, however, this is the extent of the relationship between sponsor company and partner company.

Therefore, there exists a need for improved incentive and loyalty programs in which producers and resellers are more intimately involved.

### SUMMARY

Disclosed is a buyer loyalty program (BLP) in which a reseller is intimately involved with a producer of at least a first product and sponsor of the program. In this regard, a first embodiment of the present invention may be construed as a method of operation of a reseller of at least the first product in accordance with the BLP of the producer. The method includes: receiving a membership identification of a member-buyer at the point of purchase (PoP) of a product and selling the product to the member-buyer. The method further includes: providing member-buyer purchase activity information to the producer; honoring a valid coupon from a member-buyer, wherein the valid coupon provides a discount towards a product of the producer; and receiving a refund from the producer for a portion of the discount sustained in honoring the valid coupon.

Also disclosed is a method for establishing buyer loyalty. In one embodiment, the method includes: accepting a member-buyer into a BLP and providing products to a reseller, wherein the reseller is registered in the BLP as a partner reseller of the products. The method further includes: receiving information from the reseller, wherein the information comprises purchase activity of the products by member-buyers; providing a coupon to a member-buyer when a member-buyer buys a pre-selected amount of the products from the reseller, wherein the coupon is redeemed at the reseller for a discount on products; and refunding the reseller a portion of the discount sustained by the reseller upon honoring the coupon.

Further disclosed is a method for a buyer to participate in a BLP, wherein the BLP provides discounts on selected products produced by a producer. In one embodiment, the method includes: applying for membership in the BLP, wherein upon applying, designating a particular reseller; purchasing products produced by the producer from the designated reseller; receiving a coupon from the producer upon purchasing a pre-selected amount of the products from the producer at the designated reseller; and redeeming the coupon at the designated reseller, wherein the coupon provides a discount towards the purchase of selected products produced by the producer.

### BRIEF DESCRIPTION OF THE DRAWINGS

FIG. 1 is a diagram illustrating the buyer loyalty program (BLP).

FIG. 2. is a flowchart illustrating a general method involved in the BLP of FIG. 1.

FIG. 3 is a flowchart illustrating various methods of a reseller/retailer involved in the BLP of FIG. 1.

FIG. 4 is a flowchart illustrating a general method for a producer/sponsor of the BLP of FIG. 1.

FIG. 5 is a flowchart illustrating a general method of a member-buyer in the BLP of FIG. 1.

FIG. 6 is a diagram illustrating a system for facilitating the BLP of FIG. 1.

### DETAILED DESCRIPTION

As will be described in greater detail herein, the present buyer loyalty program can improve customer loyalty and further help to increase sales of participating resellers. Increasing sales for resellers is advantageous for both the reseller and the producer, or manufacturer, in that it helps strengthen the relationship between the two.

One party involved in the buyer loyalty program (BLP) is a sponsor of the program. The sponsor of the program, in one embodiment, is the producer of particular products and/or provider of particular services involved with the BLP. The producer may also be considered a manufacturer of the products. Throughout this document these terms are used interchangeably.

Another party involved in the BLP is a reseller that is participating and/or registered in the BLP. The reseller, or retailer, sells the producer's/sponsor's products or service. The terms reseller and retailer are used interchangeably throughout this document.

A third party involved in the BLP is a buyer that may, for example, be an end-user that has taken membership in the BLP. Alternative buyers could be substituted for an end-user, such as another retailer. This latter scenario may be prohibited, however, by the sponsor of the program. Each member-buyer may designate a particular reseller upon becoming a member in the BLP. A member-buyer may also have multiple accounts in the BLP, whereby each account may be with a different reseller.

It is noted that the identified above terms are merely descriptive and terms defining parties having these same or equivalent purposes and functions in the buying and selling process would suffice.

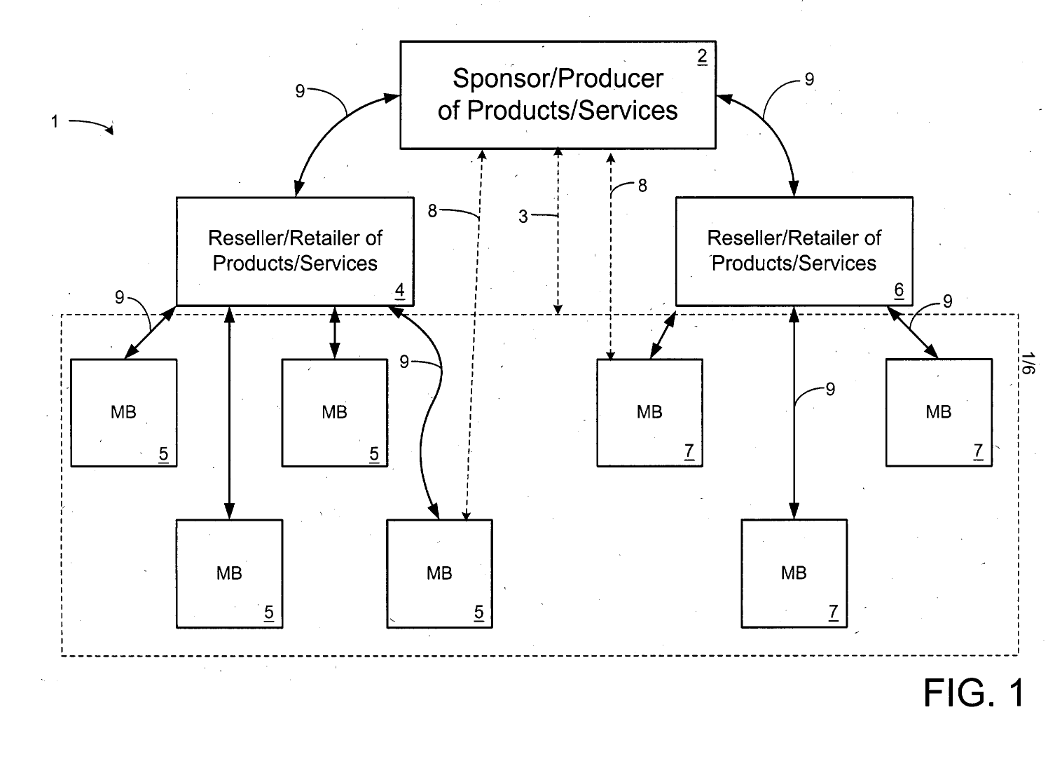

In this regard, FIG. 1 is a diagram illustrating the BLP 1. As mentioned, the BLP 1 generally includes three parties: a producer of products or services 2, a reseller/retailer of the products or services 4 and 6, and a plurality of member-buyers 5 and 7. The BLP 1 may be sponsored by the producer of the products and services 2 with participation by the reseller/retailers 4 and 6. Generally, the producer of the products or services 2 provides a variety of products or services to a particular reseller/retailer 4 or 6 through a sales channel 9. A plurality of different resellers or retailers may be involved in the program. Member-buyers 5 and 7 may become members in the BLP 1 in a variety of fashions. Generally, a member-buyer 5 or 7 may be designated to a particular reseller or retailer 4 or 6. For example, member-buyers 5 would be allocated to reseller/retailer 4. Whereas, member-buyers 7 would be allocated to reseller/retailer 6.

Several communication channels may exist within the BLP 1. Sales channel 9 serves to distribute the products downward from the producer 2 to the retailers 4 and 6 and further from the reseller/retailers 4 and 6 to the member-buyers 5 and 7. In an upward direction in the sales channel 9, coupons may be redeemed to provide discounts on products. A mass communication channel 3 may exist between the producer of the products and services 2 and a general member-buyer population. The mass communication channel 3 may be supported in a wide variety of ways, such as e-mail or mass mail distributions. Unique communication channel 8 may exist between member-buyer 5 or 7 and producer 2 which may be a two-way communication channel. The unique communication channel 8 may be utilized to provide coupons to the member-buyer 5 or 7 or other specific information. Likewise, the unique communication channel 8 may be utilized by the member-buyer 5 or 7 to communicate directly with the producer 2. The unique communication channel 8 may exist in a wide variety of ways such as, e-mail, via a web site, and/or via a customer service center.

The general structure of the buyer loyalty program 1 having been described, a general operation of the program 1 will now be discussed. Generally, the producer 2 serves as a sponsor of the BLP 1. Member-buyers 5 and 7 sign up for membership in the BLP 1 and designate a particular reseller 4 or 6. For instance, members-buyers 5 may be designated to only reseller 4, whereas member-buyers 7 may be designated to only reseller 6, however, cross-designation may not exist between resellers. As mentioned earlier, a member buyer may have more than one account, so for example, member-buyer 5 may have one account in the BLP 1 designating reseller 4 and another account designating reseller 6. Reseller 4 and 6 may become members of the program as licensed (or registered) resellers of the producer's 2 products. Member-buyer 5 may buy producer's 2 products at reseller 4 and receive points for purchasing the products. The purchase activity of the member-buyer 5 at the reseller 4 may be communicated up to the producer 2 and processed. Once a particular member-buyer 5 has reached a particular hurdle in purchasing, the producer 2 eventually provides a coupon to the member-buyer 5 through the unique communication channel 8. The coupon may be provided periodically, for example monthly or quarterly. That particular member-buyer 5 may then redeem the coupon at reseller 4 for discounts of subsequent products. The reseller 4 then in turn charges the discount to the producer 2 for refund. This same general operation exists for member-buyer 7 via reseller 6.

The BLP 1 essentially provides incentive to purchase the producer's 2 products by the member-buyers 5 and 7 and also inspires brand loyalty. Furthermore, the BLP 1 is attractive to a reseller (4 or 6) because it may increase sales for the reseller 4 or 6 by a particular member-buyer 5 or 7. Preferably, the resellers 4 and 6 are configured for e-business with an appropriate web site, and the BLP 1 is configured to provide for web traffic to the web sites of the resellers 4 and 6.

Below are several flowcharts that are provided to better illustrate various-aspects of the BLP. Each block of the flowcharts depicted herein may represent a module segment or step. The functions noted in various blocks may occur out of the order in which they are depicted. In some embodiments, the blocks may be executed in the reverse order depending upon the functionality involved. All such modifications and variations are intended to be included herein within the scope of the disclosure.

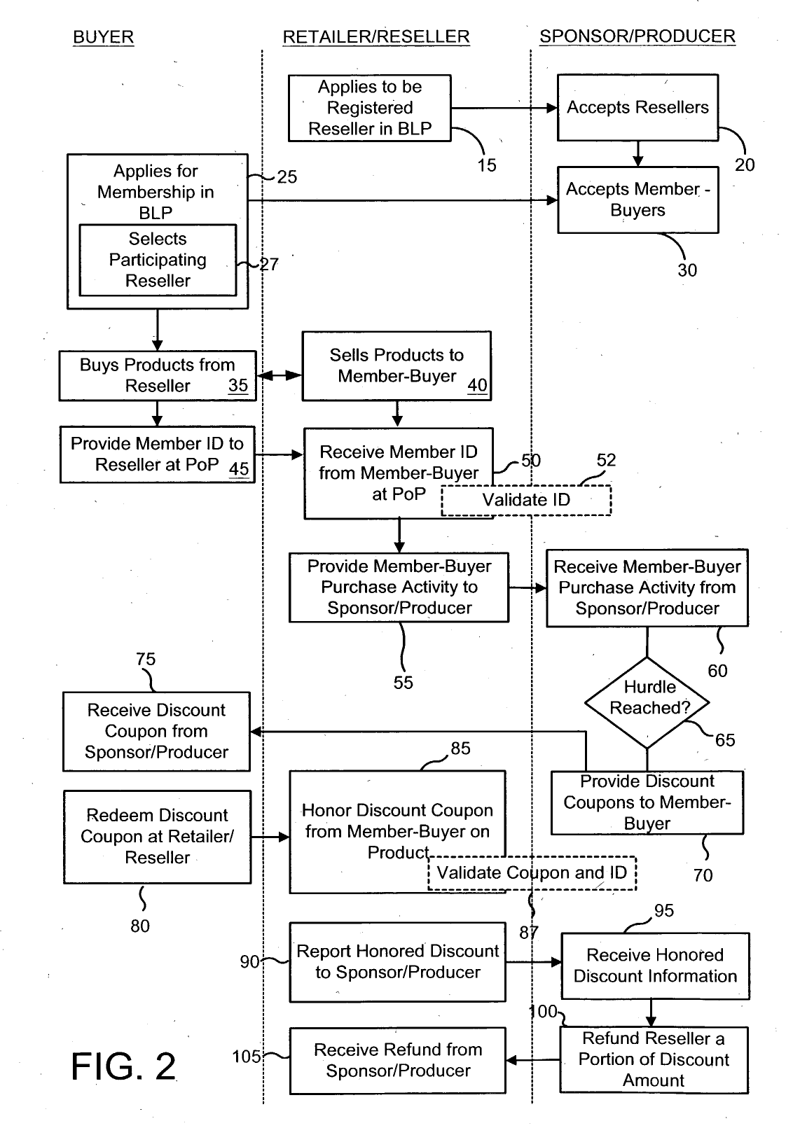

FIG. 2 is a flowchart illustrating a general method 10 of the BLP of FIG. 1. The method 10 begins with a reseller applying to be registered in the BLP (step 15). Next, the producer, or sponsor, of the BLP accepts or rejects the reseller's application (step 20). Once a variety of retailers/resellers have become registered in the program, member-buyers may apply for membership in the BLP (step 25). In applying for membership in the BLP, the member-buyer designates a participating reseller (step 27). The sponsor/producer may then, in turn, accept or reject a member-buyer's application. During the application process, member-buyer information is communicated to the sponsor/producer. For example, the applicant's name, address, phone number, title, etc. may be provided. The information that is provided to the sponsor/producer by the member-buyer (applicant) upon application may be retained and utilized by the producer/sponsor of the BLP for marketing purposes.

Once a member-buyer has established membership in the BLP and has designated a participating reseller, the method 10 continues with the member-buyer buying products of the producer at its designated reseller (step 35). Subsequently, that reseller sells the products to the member-buyer (step 40). It should be noted that a member-buyer could purchase the producer's products from any retailer at any time. However, to receive credit towards discounts in the BLP, the member-buyer must buy the producer's products from its designated reseller. Likewise, any buyer could purchase the producer's products from any reseller but not receive credit towards discounts until that buyer has become a member in the BLP. At the point of purchase (PoP) of the products, the member-buyer provides a membership identification (ID) to the reseller (step 45). The reseller receives the membership ID from the member-buyer and, in turn, may attempt to validate the ID (step 52). The reseller may communicate with the producer at the PoP to validate the identification. Alternatively, the reseller may simply provide the membership identification to the producer along with the purchase activity, thus avoiding the step of validating the identification.

Once the purchase is complete, the reseller provides the member-buyer purchase activity to the producer (step 55) and, in turn, the producer receives the purchase activity from the reseller (step 60). The producer may then process this information into a general database of the BLP. This general purchasing process may be repeated for some time until the member-buyer reaches a predetermined purchase hurdle. Once the purchase hurdle has been reached by the member-buyer (step 65), the producer then provides a coupon to the member-buyer (step 70).

The purchase hurdle structure may vary with the particular configuration of the BLP 1. For example, the hurdle structure may be arranged in a tiered structure, where at designated total purchase levels, a reward, such as a coupon, is earned. The greater the total purchase level attained, the greater the reward. The discrete purchase levels may vary with the configuration of the BLP. Typically, the purchase levels are calculated by the producer in line with the desired marketing and sales goals of the producer. A point system can be utilized to quantify the value of the purchased products. In addition, a period of time of validity may be set up for qualifying purchases. In this regard, a member-buyer would have to reach a reward purchase level before a qualifying purchase's time period expired. Other equivalent reward programs known by those skilled in the art could be utilized as well.

The member-buyer subsequently receives the coupon from the sponsor/producer (step 75). As discussed in FIG. 1, the coupon may be provided to the member-buyer through unique communication channel 8. In one embodiment, the coupon is provided to the member-buyer via an e-mail, whereby the coupon would be an e-coupon. In an alternative embodiment, the coupon may be mailed to the member-buyer. In yet other alternatives, the member-buyer may receive notification of a coupon and receive information on how to access and redeem the coupon (i.e., via a web site). The reseller may also distribute the coupons on behalf of the producer to those member-buyers that have designated that reseller.

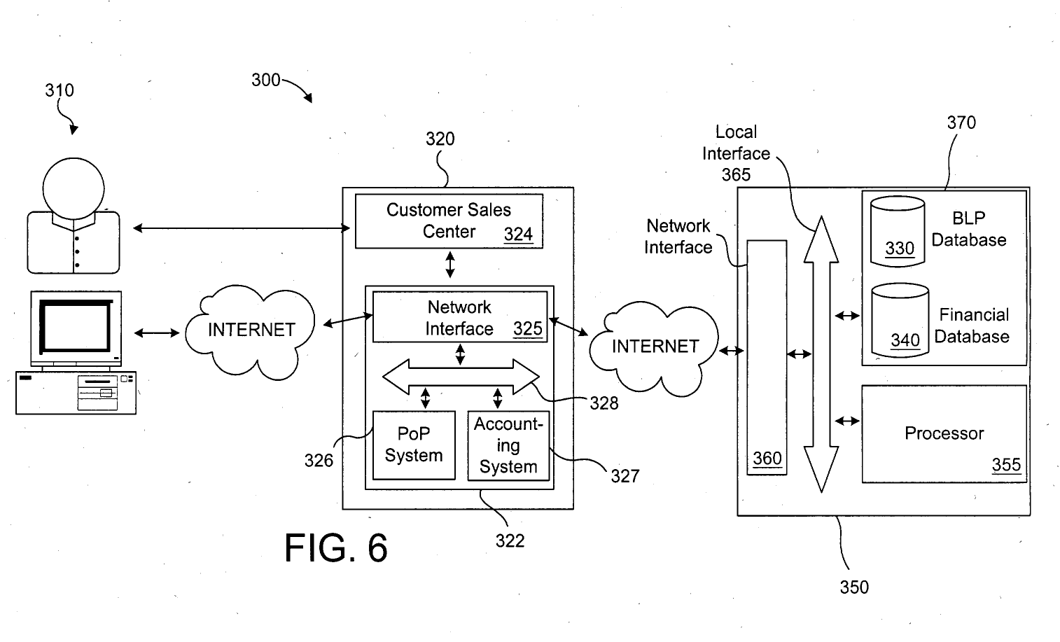

Once the member-buyer has received the coupon, the member-buyer may redeem the coupon at the designated reseller that they have selected in the BLP (step 80). The designated retailer/reseller may honor that coupon from the member-buyer at the PoP of a particular product. The step of honoring the discount may require the step of validating the coupon redeemed by the member-buyer as well as the membership ID of the member-buyer (step 87). Validation of the coupon and the membership ID may require communication at the PoP between the producer and the reseller. FIG. 6 discusses an exemplary redemption process of the coupon and membership ID. As discussed, the member-buyer may receive the coupon (e-coupon) via email. In this case, the member-buyer may redeem the coupon at the web site of the designated reseller. This scenario would require the reseller to be configured for e-commerce. Alternatively, the e-coupon may be printed and provided to a “bricks-and-mortar” type reseller.

Once the coupon has been honored by the reseller, the reseller reports the honored discounts to the sponsor/producer (step 90) wherein the honored discount information is received by the sponsor/producer (step 95). In turn, the producer refunds the reseller a portion of the discount amount sustained in honoring the coupons (step 100). The reseller may then receive the refund from the producer (step 105).

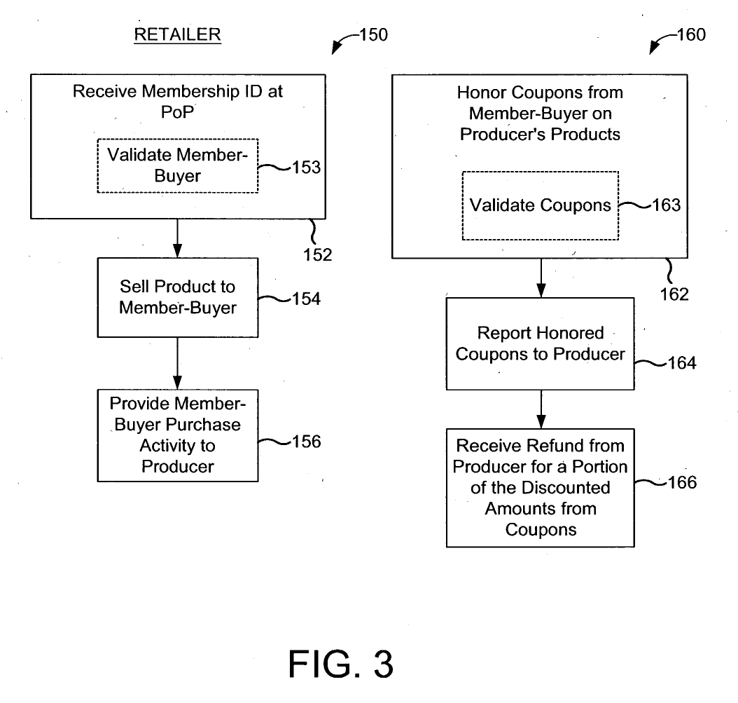

FIG. 3 is a flowchart illustrating various methods of a reseller/retailer involved in the BLP of FIG. 1. Method 150 begins with the reseller receiving a membership ID of a member-buyer at the PoP of a particular product(s) (step 152). At the PoP, the reseller may validate the member-buyer's membership ID (step 153). As discussed in relationship to FIG. 2, this-may require communication with the producer. Alternatively, the step 153 of validating the membership ID may be avoided by providing such information with the purchase activity to the producer at a later time. Subsequently, the reseller sells the product(s) to the member-buyer (step 154). The purchase activity of the member-buyer is recorded and eventually provided to the producer (step 156). The method 150 may be performed multiple times on multiple occasions with a particular member-buyer. Likewise, the method 150 may be performed with multiple different member-buyers. Step 156 may be performed on a routine basis, for instance, daily, or weekly. Alternatively, this step 156 may be performed after every transaction in which a member-buyer purchases a producer's product(s) that are involved in the BLP.

The redemption process 160 begins with the reseller honoring a coupon(s) from a member-buyer on a producer's product(s) (step 162). This step may require validating the coupons as well as validating the member-buyer's membership ID (step 163). The validation step may require communication with the producer, as mentioned in relation to FIG. 2. Provided the coupon is valid, the reseller then sells the producer's product(s) to the member-buyer at the discounted price, which is determined by the sale price of the product(s) and the discount provided by the coupon(s). The reseller then reports the honored discounted coupons to the producer (step 164) and then receives a refund from the producer for a portion of the discounted amounts from the coupons (step 166). Similar to step 156, the reseller may report the honored coupon(s) information (step 164) on a routine basis, for instance, daily, or weekly. Likewise, the honored coupon(s) information may be provided to the producer after each transaction in which they are honored. As will become clearer upon discussion of FIG. 6, the honored discount information may be provided to the producer by charging the discount to a designated account, (e.g., Visa™) that would have been established beforehand. In this same regard, the step of receiving the refund from the producer (step 166) may be done routinely as well, and can be synchronized to the routine of step 164. The refund may be received from the producer through the account, in which case, the process can be completely electronic and seamless. In some embodiments, the received refund is 100% of the discounted amount. Alternatively, however, only a portion, for example 75%, may be received from the producer to refund the discounted amount sustained by the reseller. The percentage of the discounted amount to be refunded may be negotiated between the two parties.

The communication between the reseller and the producer, for example reporting the honored coupons to the producers (step 164) and providing the member-buyer purchase activity to the producer (step 156), may be accomplished electronically via e-mail or via download. As just discussed in reporting the honored coupon to the producer in step 164, this may be done by charging the discount to a particular account held by the producer. Likewise, communication between the member-buyer and the reseller may be done electronically via the Internet and a web site. The member-buyer's membership ID may be received at the PoP on a web site and thus validated at that point electronically with the producer. Similarly, e-coupons may be honored by the retailer via a web site operated by the reseller.

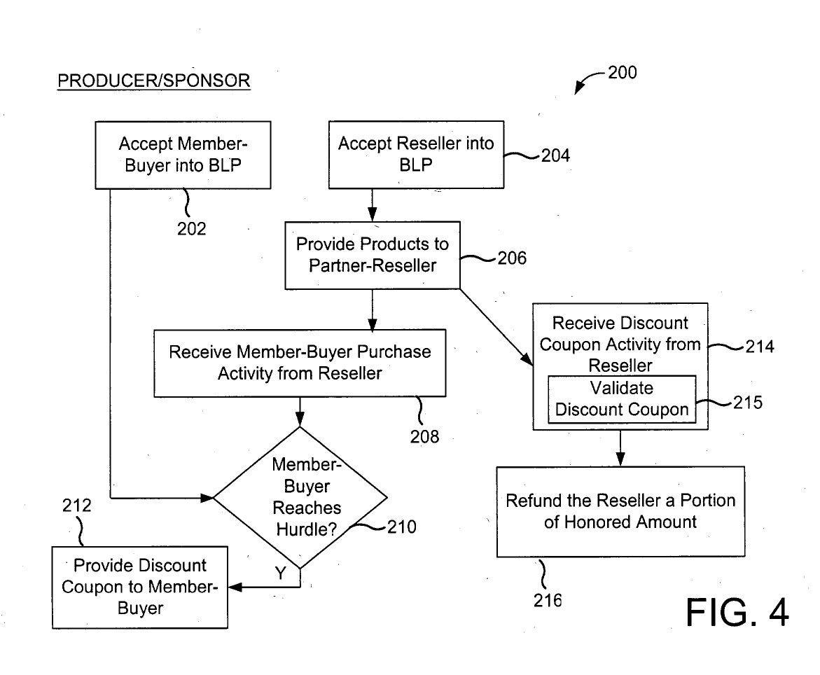

FIG. 4 is a flowchart illustrating a general method 200 for the producer/sponsor of the BLP 1 of FIG. 1. The method 200 begins when the producer accepts member-buyers into the BLP (step 202) and accepts resellers into the BLP (step 204). The producer then provides qualifying products to a partner reseller (step 206) that would be included in the BLP. It should be noted that not every product provided by the producer need be included in the BLP. The BLP, as its name suggests, is intended to build loyalty in its products. Typically, the types of products that are associated with the BLP are consumer durables, i.e., products that get consumed in volume. Office supplies, for example, would be offered as products in the BLP. In this case, the member-buyers may be the purchasing officers of small businesses.

The producer may receive member-buyer purchase activity from a particular reseller (step 208). The producer may then process this information into a database and determine when a member-buyer reaches a particular purchasing hurdle (step 210). Once a purchase hurdle has been reached by a member-buyer, the producer provides a coupon (which may be an e-coupon) to the member-buyer (step 212). This step 212 may be performed periodically, such as quarterly or monthly.

During the redemption process, the producer receives the coupon activity from a particular reseller (step 214). The coupon activity may be provided in a number of ways and may include a variety of information. For instance, the coupon information may be provided through a charge account set up by the producer and the reseller. The coupon information may include the product(s) that are to be discounted, the coupon information, and member-buyer membership ID. In other embodiments, information regarding the entire purchase by the member-buyer may be communicated to the producer. This information may be utilized to build and analyze a member-buyer's purchasing patterns.

At any PoP, the producer may receive a request for verification of the member-buyer's membership ID, and also the coupon (step 215) (upon redemption). The verification process may be completed electronically. An example of such electronic verification is discussed in further detail in FIG. 6.

Once the discounted coupon information has been received and processed, the producer then refunds the reseller a portion of the honored amount (step 216). As mentioned in FIG. 3, the portion of the amount refunded by the producer may be 100% of the discounted amount sustained by the reseller. In alternative embodiments a smaller portion, such as 75%, is refunded to the reseller. Generally, this amount may be negotiated between the producer and the reseller upon acceptance into the BLP. The step of refunding may be performed by paying the reseller the amount entered in the charge account.

The producer may mass-communicate with the member-buyers to provide general information in regards to the BLP. The producer may also communicate individually with member-buyers to communicate purchase activity information as well as other general information regarding the products of the producer. Likewise, the producer may receive communication from the member-buyers in regard to particular questions about the products, about the BLP itself, and about the purchase activity of that particular member-buyer.

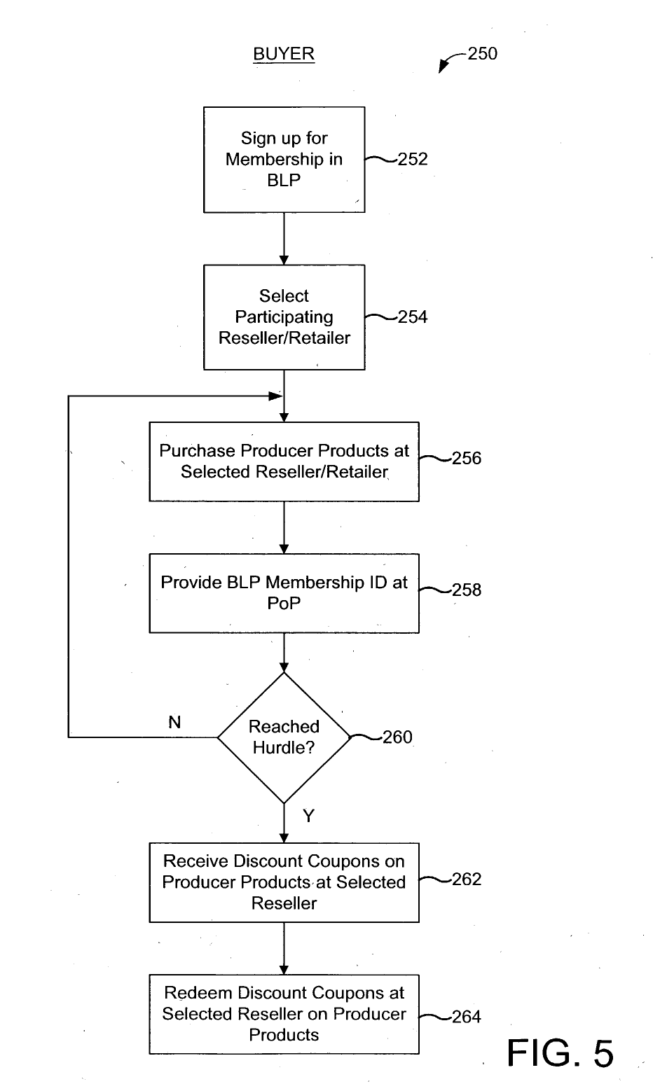

FIG. 5 is a flowchart illustrating a general method 250 as performed by a member-buyer in the BLP 1 of FIG. 1. Method 250 begins with a buyer signing up for membership in the BLP (step 252). During sign-up, the buyer may select a participating reseller that is involved in the BLP (step 254). At sign-up, the buyer may provide general information to the producer, such as personal identification information including name, address, phone number, title, etc. Optionally, the applying buyer may establish membership in the BLP by accessing a web site set up for the BLP by the producer. From this website, the applying buyer may also designate his/her participating reseller. From this web site, the applying buyer may provide the requested information. Alternatively, the buyer may apply for membership via its designated reseller. In return, the now member-buyer receives a membership ID. The ID may be as simple as a number or may be a physical object holding the identification. Examples of such an item include a card that has a magnetic strip carrying the information, a card with a printed bar code conveying the identification, or an electromagnetic device that when coupled to an appropriate reader, may convey the appropriate information.

Once membership has been established in the BLP, the buyer may then purchase the producer's products at his or her designated reseller (step 256). At the PoP of these products, the member-buyer provides the membership ID to the reseller (step 258).

Once a member-buyer has reached a purchase hurdle (step 260), the member-buyer then receives a coupon from the producer to be redeemed on the producer's product(s) at the selected reseller (step 262). The member-buyer may then redeem the coupons at the selected reseller on the producer's product(s) (step 264).

As mentioned in the foregoing, it would be desirable to enable the member-buyer to make purchases electronically via a reseller's web site. The designated reseller may have a specially configured e-commerce web site that may request a member-buyer membership ID when a producer's product is to be purchased. Redemption of coupons, in this case, e-coupons, could be done via the same web site. This way, communication between member-buyer, reseller, and producer can be done with minimal human interaction. This may help in keeping down the operating cost of the BLP. The method of redemption as illustrated in FIG. 6 provides for minimal human interaction between the three parties.

Attention is now directed to FIG. 6 which illustrates a system 300 for facilitating the BLP. The system 300 includes a computer system 322 of a reseller 320 and a computer system 350 of a sponsor/producer of the BLP, which can communicate with each other via the Internet, or some other electronic communication. The computer systems 322 and 350 may be made up of a single server or may be made up of a network of servers and mainframes.

The reseller computer system 322 includes, among other systems, a PoP system 326 for communicating with a member-buyer 310 and an, accounting system 327. The reseller computer system 322 further includes a network interface 325 for providing network access, such as Intranet and Internet access. The network interface 325 may communicate with the PoP system 326 and the accounting system 327 through a local interface 328. In the case where the reseller computer system 322 is comprised of one server, the local interface 328 may be considered a local bus of the one server. In this case, the network interface 325 may be a network interface card or a communication modem. In the case where the reseller computer system 322 has a distributed architecture (i.e., several different servers having distinct responsibilities), the local interface 328 may serve as a local area network (LAN) providing connectivity to (i.e., an access point) each of the servers. In this case, the network interface 325 may serve as a gateway to the Internet and other external networks for the LAN.

The reseller 320 may also include a telephone customer sales center 324 manned with several customer service representatives. The customer service representatives may have direct access to the PoP system 326 and the accounting system 327. This provides for alternative means of communicating with the reseller 320 by a member-buyer 310. The member-buyer 310 may also communicate directly with the computer system 322 of the reseller 320 via the Internet and an e-commerce enabled web site provided by the reseller 320. The web site provided by the reseller 320 may be stored and maintained by the PoP system 326, which may be configured as a web server. The PoP system 326 and/or the customer sales center 324 provide for a PoP of the various products offered by the producer in the BLP to the member-buyer 310 as well as a location for the member-buyer 310 to redeem a coupon. The PoP system 326 may be configured with proprietary software for accessing various resources of the sponsor computer system 350. The software can thus enable the reseller computer system 322 to verify the validity of a coupon being redeemed at the PoP system 322, as well as validate the membership identification of the member-buyer 310 attempting to redeem the coupon.

The reseller computer system 322 also includes an accounting system 327 for tracking the products of the producer sold by the reseller, as well as the discounts sustained through honoring coupons. As an alternative to configuring the PoP system 326, the accounting system 327 may be configured to communicate with the sponsor/producer computer system 350, via the network interface 325, to verify a coupon as well as the identification of the member-buyer 310. The accounting system 327 may also be configured, with proprietary software, to charge discounts sustained to a specific charge account. The discounts would be sustained upon honoring a valid coupon and eventually would be reimbursed by the sponsor of the BLP. The specific charge account, as will be discussed shortly, may be stored in a database residing on the sponsor computer system 350 or may be provided by a third party.

The sponsor computer system 350, in general terms, includes a network interface 360, memory 370, and a processor 355, all coupled to a local interface 365. Similar to the computer system 322, the computer system 350 contains the necessary hardware, software, and firmware to securely communicate with the computer system 322 of the reseller. Furthermore, the computer system 350 also includes the necessary hardware, software, and firmware to communicate a variety of information to member-buyers, such as coupon information.

The network interface 360 may provide access for the sponsor computer system 350 to an external network, such as the Internet. Furthermore, the network interface 360 may provide access for external systems, such as the reseller computer system 322, to resources in the sponsor computer system 350.

The memory 370 may be any combination of read-only memory (ROM), random access memory (RAM) as well as hard drive space. The memory 370 includes a BLP database 330 that may store various information regarding the BLP. For example, the database 330 may include information about the member-buyers in the BLP, such as identification number, name, address, etc. The database 330 may also include information regarding the validity of coupons in the BLP. Each coupon may be tied in with a particular member-buyer. For example, one coupon may be available to one member-buyer that has achieved a higher purchasing threshold than a second member-buyer that has a second coupon. Furthermore, the database 330 keeps track of what coupons have been redeemed. Tracking this information helps in reducing “over-discounting,” that is, providing a discount more than once for a single coupon.

The memory 370 may also include a financial database 340 which can store discount-charge accounts of the various resellers in the BLP. The financial database 340 may alternatively be provided by a third party financial institution such as a bank that provides for Internet account accessibility.

The memory 370 may also store various programs related to the BLP. For example, a program may include an algorithm for verifying a coupon. Another program may include an algorithm for tracking the purchase activity of the member-buyers in the BLP, as well as providing the coupons to those member-buyers that reach certain purchasing hurdles. Yet another program may include an algorithm for handling the communications with the member-buyers.

The processor 355 may execute the various programs incorporated into the BLP. The processor 355 may be any general purpose processor such as a PC microprocessor. The processor 355 may access the programs in memory 370 via the local interface 365.

FIG. 6 illustrates the system 300 implementing a redemption process that involves minimal human interaction. This redemption process takes into consideration the idea that a participating retailer, or reseller 320, does not have the capability to validate a coupon. This idea is believed to be realistic and attractive to the reseller 320, in that the necessary coupon validation system and database may not be incorporated into the systems of the reseller but is provided by the producer of the products. Alternatively, however, the contents of the BLP database 330 may periodically be downloaded to the reseller computer system 322, so that the reseller 320 can perform the validating without accessing the sponsor computer system 350.

The system 300 functions with a member-buyer 310 placing an order with its designated reseller 320 for a product(s) of the sponsor/producer. The order may also include other products offered for sale by the reseller 320. The order may be placed electronically, via the Internet, at a web site stored on the computer system 322 of the reseller 320, or may be placed over the telephone via the customer sales center 324 of the reseller 320. Alternatively, the member-buyer 310 may place the order in a “bricks-and-mortar” type reseller location. At the PoP, the member-buyer 310 references the coupon.

At this point, the reseller 320 sends the coupon information and possibly the member-buyer membership ID to the producer. This may be accomplished electronically from the computer system 322 to the computer system 350 via a secure connection. The computer system 350 may query the database 330 with the coupon information so as to verify its validity. This process typically is completed during the PoP, so as to immediately communicate the validity of the coupon back to the member-buyer 310.

The computer system 350, upon searching the database 330, may communicate the validity of the coupon back to the computer system 322. If the coupon is found to be invalid, perhaps because it was already redeemed, or perhaps it is registered to another member-buyer, the member-buyer 310 is notified and a discount is not provided as to the particular product.

If the coupon is found to be valid, a discount is provided for the purchase of the particular product. The reseller 320 may debit the discounted amount from the charges to the member-buyer 310 and charge the discounted amount to a specific account stored in the financial database 340. The accounting system 327 may include the necessary resources to perform these tasks.

At this point the coupon redemption process would be complete. Periodically, perhaps weekly, monthly, or quarterly, the specific accounts in the financial database 340 may be paid to the reseller 320 by the producer, as if it were a bill.

The BLP and/or methods described herein may be implemented by software, hardware, or firmware, or any combination thereof. For example, the system 300 of FIG. 6 could be implemented with software that helps in accessing and communicating information that may be stored in a computer database. In this same regard, various different types of hardware platforms may be utilized in accessing and validating a member-buyer's membership ID. The use of software, hardware, and/or firmware should be considered reasonable tools by which embodiments of the present invention may be implemented, and so are intended to be included herein. The various software and/or firmware programs can be embodied in any computer-readable medium for use by or in connection with an instruction execution system, apparatus, or transmission device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the information system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable media would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

1. A method for facilitating buyer loyalty, the method comprising:
receiving a membership identification of a member-buyer of a buyer loyalty program (BLP) at the point of purchase (PoP) of a product;
selling a first product to the member-buyer;
providing member-buyer purchase activity information to a producer of the product, wherein the producer serves as a sponsor of the BLP;
honoring a valid coupon from a member-buyer, wherein the valid coupon provides a discount towards a second product of the producer; and
receiving a refund from the producer for a portion of the discount sustained in honoring the valid coupon.

2. The method of claim 1, wherein the step of selling is performed via the Internet and an e-commerce site of the reseller.

3. The method of claim 2, wherein the valid coupon is an e-coupon and wherein the step of honoring the e-coupon is performed via the e-commerce site of the reseller.

4. The method of claim 1, wherein the step of receiving the membership identification comprises:
receiving a membership card from the member-buyer; and
retrieving the membership identification from the membership card.

5. The method of claim 1, wherein the membership identification comprises at least one of the following of a member-buyer: name, address, email, telephone number, or membership number.

6. The method of claim 1, wherein the step of providing member-buyer purchase activity information comprises:
providing the membership identification of the member-buyer to the producer;
providing an identity of the product purchased to the producer; and
providing the quantity of the product purchased.

7. The method of claim 1, further comprising:
establishing a membership in the BLP as a participating reseller.

8. The method of claim 1, further comprising:
verifying whether a buyer is a valid member of the BLP at the point of purchase.

9. The method of claim 8, wherein the step of verifying comprises:
providing the membership identification to the producer, whereby the producer establishes whether the membership identification is valid; and
receiving a reply communication from the producer communicating whether the membership identification is valid.

10. The method of claim 1, wherein the member-buyer is registered as a member of the BLP for that particular reseller.

11. The method of claim 10, further comprising:
verifying whether a member-buyer is registered for that particular reseller.

12. The method of claim 1, wherein the step of honoring a valid coupon comprises:
verifying whether the coupon is valid.

13. The method of claim 12, wherein the step of verifying comprises:
communicating to the producer, the coupon to be validated; and
receiving an acceptance or a rejection as to the validity of the coupon.

14. The method of claim 12, wherein the step of verifying comprises:
accessing a database provided by the producer, wherein the database comprises information regarding the validity of the coupon.

15. The method of claim 1, wherein the producer is a manufacturer and the at least first product is a physical product.

16. The method of claim 1, wherein the producer is a service provider and the at least first product is a unit of service.

17. A method for establishing buyer loyalty, comprising:
accepting a member-buyer into a buyer loyalty program (BLP);
providing products to a reseller, wherein the reseller is registered in the BLP as a partner reseller of the products;
receiving information from the reseller, wherein the information comprises purchase activity of the products by member-buyers;
providing a coupon to a member-buyer when a member-buyer buys a pre-selected amount of the products from the reseller, wherein the coupon is redeemed at the reseller for a discount on products; and
refunding the reseller a portion of the discount sustained by the reseller upon honoring the coupon.

18. The method of claim 17, wherein the step of accepting a member-buyer comprises:
receiving information about the member-buyer; and
providing a membership identification to the member-buyer upon membership.

19. The method of claim 18, wherein the step of accepting a member-buyer further comprises:
providing a membership identification card to the member-buyer, wherein the membership identification card comprises membership identification of the member-buyer.

20. The method of claim 17, wherein the coupon is an e-coupon and wherein the step of providing a coupon comprises:
providing the e-coupon to the member-buyer electronically.

21. The method of claim 20, wherein the coupon is an e-coupon and wherein the step of providing a coupon comprises:
providing the e-coupon via an email.

22. The method of claim 17, wherein the portion of the discount sustained is 100%.

23. The method of claim 17, wherein the step of refinding the reseller a portion of the discounted amount comprises:
providing and enabling a charge account to be utilized by the reseller, whereby the reseller may charge the discounted amount to the charge account; and
paying a portion of a balance of the charge account to the reseller.

24. The method of claim 23, wherein the step of paying the portion of the balance is performed electronically.

25. The method of claim 17, further comprising:
verifying whether the membership identification of the member-buyer is valid; and
validating a coupon that is to be honored by a reseller.

26. The method of claim 25, wherein the step of validating comprises:
receiving a communication form the reseller, wherein the communication comprises the coupon information to be validated;
accessing records to verify the validity of the coupon; and
notifying the reseller of the validity of the coupon.

27. The method of claim 25, wherein the step of validating comprises:
providing a database, wherein the database comprises information regarding the validity of the coupon; and
enabling the database to be accessed by a reseller, whereby the reseller can perform the validation of the coupon.

28. A method for a buyer to participate in a buyer loyalty program (BLP), wherein the BLP provides discounts on selected products produced by a producer, the method comprising:
applying for membership in the BLP, wherein upon applying, designating a particular reseller;
purchasing products produced by the producer from the designated reseller;
receiving a coupon from the producer upon purchasing a pre-selected amount of the products from the producer at the designated reseller; and
redeeming the coupon at the designated reseller, wherein the coupon provides a discount towards the purchase of selected products produced by the producer.

29. The method of claim 28, wherein the step of applying for membership comprises:
providing information to the producer; and
receiving a membership identification from the producer.

30. The method of claim 29, wherein the information provided to the producer comprises at least one of the buyer: name, address, email, or telephone number.

31. The method of claim 29, wherein the step of applying for membership further comprises:
receiving a membership identification card from the producer, wherein the membership identification card comprises a membership identification.

32. The method of claim 29, wherein the steps of providing information and receiving an identification are done electronically.

33. The method of claim 29, wherein the steps of providing information is done via the designated reseller.

34. The method of claim 28, wherein the step of purchasing comprises:
providing a membership identification to the reseller at the PoP.

35. The method of claim 28, wherein the step of redeeming a coupon comprises:
providing a membership identification to the reseller at the PoP; and
providing the coupon to the reseller.

36. The method of claim 28, wherein the coupon is an e-coupon and wherein the step of redeeming the e-coupon is done electronically via an e-commerce enabled web site.

37. A program stored on a computer-readable medium for honoring a coupon provided by a sponsor of a buyer loyalty program (BLP), the program comprising:
logic configured to receive an identification of a member-buyer of the BLP;
logic configured to receive an identification of the coupon from the member-buyer;
logic configured to verify the validity of the coupon with regard to the identification of the member-buyer; and
logic configured to apply the discount related to the coupon to a particular product being purchased by the member-buyer, provided the coupon is valid.

38. The program of claim 37, wherein the logic configured to verify comprises:
logic configured to communicate the identification of the member-buyer and the identification of the coupon to the sponsor; and
logic configured to receive a communication from the sponsor, wherein the communication conveys the validity of the coupon.

39. The program of claim 37, further comprising:
logic configured to charge the discount provided by the honored coupon to a designated charge account of the sponsor; and
logic configured to receive a refund from the sponsor for a portion of an amount in the designated charge account.

40. A program stored on a computer-readable medium for facilitating a buyer loyalty program (BLP), the program comprising:
logic configured to accept a member-buyer into the BLP;
logic configured to accept a reseller into the BLP, wherein the reseller is registered in the BLP as a partner reseller of a select group of products produced by a sponsor of the BLP;
logic configured to receive information from the reseller, wherein the information comprises purchase activity of the products by member-buyers;
logic configured to provide a coupon to a member-buyer when a member-buyer buys a pre-selected amount of the products from the reseller, wherein the coupon is redeemed at the reseller for a discount on products; and
logic configured to refund the reseller a portion of the discount sustained by the reseller upon honoring the coupon.

41. The program of claim 40, further comprising:
logic configured to receive a validation request by the reseller, wherein the request is to validate an identification of the member-buyer and a coupon redeemed at the reseller by the member-buyer; and
logic configured to validate the identification of the member-buyer and the coupon; and
logic configured to communicate to the reseller whether the coupon is valid with regard to the identification of the member-buyer.

42. The program of claim 40, wherein the logic configured to provide a coupon comprises:
logic configured to send an email to the member-buyer, wherein the email is configured to communicate the coupon.

43. A system for facilitating a buyer loyalty program (BLP), the system comprising:
a computer system of a sponsor of the BLP, wherein the sponsor is a producer of products to be sold through the BLP, and wherein the computer system of the sponsor comprises:
means for storing various information regarding the BLP; and
means for communicating with a computer system of at least a first reseller;
a computer system of a reseller of the products of the producer, wherein the reseller is registered in the BLP, and wherein the computer system of the reseller comprises:
means for providing for the sale of products of the producer to member-buyers in the BLP;
means for receiving coupons presented by the member-buyers, wherein the coupons are originally provided by the sponsor of the BLP; and
means for communicating with the computer system of the sponsor.

44. The system of claim 43, wherein the computer system of the sponsor further comprises:
logic configured to:
receive a request from the computer system of the reseller to verify if a coupon is valid;
query the database to verify the validity of the coupon; and
communicate the validity of the coupon to the computer system of the reseller.

45. The system of claim 43, wherein the computer system of the sponsor further comprises:
logic configured to provide the computer system of the reseller limited access to the database.

46. The system of claim 45, wherein the means for communicating of the computer system of the reseller further comprises:
means for accessing the database stored on the computer system of the sponsor; and
wherein the computer system of the reseller further comprises:
logic configured to query the database to determine the validity of the coupon.
